(19) United States
(12) Patent Application Publication
(10) Pub. No.: US 2020/0285738 A1
(43) Pub. Date: Sep. 10, 2020

(54) PROCESS-CENTRIC SECURITY MEASUREMENT OF CYBER-PHYSICAL SYSTEMS

(71) Applicant: Singapore University of Technology and Design, Singapore (SG)

(72) Inventors: Nils Ole Tippenhauer, Singapore (SG); Hamid Reza Ghaeini, Singapore (SG)

(21) Appl. No.: 16/812,089

(22) Filed: Mar. 6, 2020

(30) Foreign Application Priority Data
Mar. 6, 2019 (SG) 10201902011U

(51) Int. Cl. G06F 21/55; G06N 20/00; G06N 5/04

(52) U.S. Cl. CPC G06F 21/554; G06F 2221/034; G06N 5/04; G06N 20/00

(57) ABSTRACT

A system for monitoring security in a cyber-physical system comprises: a packet parser configured to obtain, from network traffic in the cyber-physical system, a plurality of sensor measurements from one or more sensors of the cyber-physical system, the plurality of sensor measurements relating to a physical process in the cyber-physical system, the physical process having a current process state; and a threat detector configured to determine, based on a model of the physical process and the current process state, whether the plurality of sensor measurements correspond to a security threat to the cyber-physical system.

### CROSS-REFERENCE TO RELATED APPLICATIONS

This patent application claims the benefit of Singapore Application No. 10201902011U, filed on 6 Mar. 2019, the entire contents of which are incorporated herein.

### FIELD

The present disclosure generally relates to improving security in cyber-physical systems, such as industrial control systems.

### BACKGROUND

Cyber-Physical Systems (CPS) are designed to control physical processes by a cyber controller. The CPS controllers are designed for real-time control of the system. However, security is recently becoming more important, given the number of cyber and physical threats that are menacing the CPS space. Mainly, the controller of the CPS is a microprocessor that is designed for real-time control of the physical system. The controller changes the physical state of the system by the actuation commands sent to the actuators, and reads the physical state by receiving sensor readings. CPSs are used in manufacturing (such as automotive manufacturing plants and chemical plants), transportation (such as aircraft, trains, and cars), infrastructure (such as power distribution, water treatment and distribution), healthcare facilities (such as hospitals), and so on.

Industrial control systems (ICS) are a sub-class of CPS able to monitor and control an industrial process autonomously. An ICS includes heterogeneously interconnected components such as remote terminal units (RTU), programmable logic controllers (PLC), telemetry systems, historian servers, and human-machine interfaces (HMI). Those components are typically reachable over the Internet, and connected to other embedded devices, resulting in a setup known as the Industrial Internet of Things (IIoT). CPS that are connected to the Internet for remote supervision and maintenance typically use protocols built on top of IP and TCP. Such connectivity raises security concerns for the CPS at both cyber and physical levels.

Intrusion Detection Systems (IDS) are designed to detect intrusions to computing devices in a CPS and in the communication channels between the computing devices. However, these intrusion detection systems are typically configured for corporate environments, and are not suitable for use with industrial systems.

To integrate an IDS with a CPS, Application Programming Interfaces (API) and protocols used by the CPS are needed. However, those systems are inflexible, relying on detection of already well-understood security threats, and an attacker can bypass the IDS by changing standard attack scenarios. Anomaly Detection Systems (ADS) are designed to detect such anomalies in the system. ADS require trusted information retrieval that can be provided by the IDS.

It would be desirable to address or alleviate at least one of the above difficulties.

### SUMMARY

Disclosed herein are security monitoring processes and systems that consider the physical process at the centre of the security measurement. In particular, embodiments may provide one or more of: (i) intrusion detection systems that securely extract the physical state of the CPS; (ii) security measurements of CPS that consider one or more underlying physical processes and their behaviour; and (iii) security applications that use process-centric measurements to improve their performance (such as detection rate in ADS).

### BRIEF DESCRIPTION OF THE DRAWINGS

Some embodiments will now be described, by way of non-limiting example only, with reference to the accompanying drawings in which:

FIG. 1 is a block diagram of the architecture of a cyber-physical system (CPS) that comprises a security monitoring system according to certain embodiments;

FIG. 2 is a block diagram of the architecture of an industrial control system (ICS) that comprises a security monitoring system in the form of an anomaly detector, according to certain embodiments;

FIG. 2 is a block diagram showing an example software architecture of the anomaly detector of the ICS of FIG. 1;

FIG. 3 shows an exemplary big data framework of the anomaly detector of FIG. 2;

FIG. 4 is a schematic of a framework for anomaly detection according to certain embodiments;

FIG. 5 is a schematic of a framework for anomaly detection according to certain embodiments;

FIG. 6 is a schematic of a machine learning framework for anomaly detection according to certain embodiments.

### DETAILED DESCRIPTION

In general terms, the present disclosure relates to process-centric security measurements for cyber-physical systems that can improve the overall security of the system by considering the physical process as a primary security measure in CPS security applications. This security measurement can be used in CPS security applications such as Intrusion Detection Systems (IDS), Anomaly Detection Systems (ADS), process verification, Remote Attestation (RA), and Integrity Checking (IC) of CPS. For example, some embodiments disclosed herein relate to implementation in an example IDS, and two example ADS.

In some embodiments, the present disclosure relates to a security monitoring process for a cyber-physical system. The process comprises obtaining, from one or more sensors of the cyber-physical system, a plurality of sensor measurements relating to a physical process in the cyber-physical system, the physical process having a current process state. The process also comprises performing a threat detection operation comprising determining, based on a model of the physical process and the current process state, whether the plurality of sensor measurements correspond to a security threat to the cyber-physical system.

The threat detection operation may, for example, be an intrusion detection operation or an anomaly detection operation.

In some embodiments, the threat detection operation comprises determining a corresponding plurality of estimated values for the at least one parameter based on the model of the physical process; and determining whether the estimated values differ from one or more expected values for the at least one parameter given the current process state. For example, the threat detection operation may comprise determining residuals between the estimated values and the sensor measurements; determining a cumulative sum (CUSUM) of normalised residuals, wherein the normalised residuals are computed according to a difference between the residuals and a historical average of the residuals for the current process state; based at least on the CUSUM, detecting whether there is an anomaly in the current process state; and responsive to detection of an anomaly, generating an alert.

The detection of the anomaly may, for example, be based on a comparison of the CUSUM with a threshold.

In some embodiments, the model of the physical process is based on system identification, and may be an autoregressive model or a linear dynamical state space (LDS) model.

In some embodiments the threat detection operation comprises a classification operation using a trained model, such as a machine learning model, that is configured to output a class prediction based on one or more input features, and wherein at least one of the input features is derived from the plurality of sensor measurements.

The one or more input features may be derived from one or more of: current actuation commands; sensor signals; estimated sensor signals; residuals between sensor signals and estimated sensor signals; a physical status of one or more devices implementing the physical process; a transition between physical statuses of the one or more devices; and one or more network traffic parameters of network traffic in the cyber-physical system.

In some embodiments, one of the input features is a cumulative sum (CUSUM) of normalised residuals, wherein the normalised residuals are computed according to a difference between the residuals and a historical average of the residuals for the current process state.

In some embodiments, the one or more network traffic parameters are derived from network packets at both process level and basic control level devices of the cyber-physical system.

The present disclosure also relates to a system for monitoring security in a cyber-physical system. The system may comprise a packet parser configured to obtain, from network traffic in the cyber-physical system, a plurality of sensor measurements from one or more sensors of the cyber-physical system, the plurality of sensor measurements relating to a physical process in the cyber-physical system, the physical process having a current process state. The system may also comprise a threat detector configured to determine, based on a model of the physical process and the current process state, whether the plurality of sensor measurements correspond to a security threat to the cyber-physical system.

In some embodiments, the threat detector is configured to determine a corresponding plurality of estimated values for at least one parameter based on the model of the physical process; and to determine whether the estimated values differ from one or more expected values for the at least one parameter given the current process state.

In some embodiments, the packet parser and/or the threat detector are configured to determine residuals between the estimated values and the sensor measurements; determine a cumulative sum (CUSUM) of normalised residuals, wherein the normalised residuals are computed according to a difference between the residuals and a historical average of the residuals for the current process state; based at least on the CUSUM, detect whether there is an anomaly in the current process state; and responsive to detection of an anomaly, generate an alert. For example, the packet parser may be configured to determine the residuals and the CUSUM, and the threat detector may be configured to detect the anomaly and to generate the alert in the event of a detection.

The detection of the anomaly by the threat detector may be based on a comparison of the CUSUM with a threshold.

In some embodiments, the threat detector may be configured to carry out a classification operation using a trained model that is configured to output a class prediction based on one or more input features, wherein at least one of the input features is derived from the plurality of sensor measurements.

For example, the one or more input features may be derived from one or more of: current actuation commands; sensor signals; estimated sensor signals; residuals between sensor signals and estimated sensor signals; a physical status of one or more devices implementing the physical process; a transition between physical statuses of the one or more devices; and one or more network traffic parameters of network traffic in the cyber-physical system.

In some embodiments, one of the input features is a cumulative sum (CUSUM) of normalised residuals, wherein the normalised residuals are computed according to a difference between the residuals and a historical average of the residuals for the current process state.

In some embodiments, the packet parser is configured to derive the one or more network traffic parameters from network packets at both process level and basic control level devices of the cyber-physical system, for example, the level 0 (process level) and level 1 (basic control level) of the industrial control system.

The present disclosure further relates to non-transitory computer-readable storage having stored thereon instructions for causing at least one processor to perform a security monitoring process as disclosed herein.

The present disclosure is predicated on the realisation that actuation commands carried out in a cyber-physical system will change the physical state of the system, and these changes of the physical state will be represented in sensor readings. The unique pattern or signature of the physical states and the transitions between them can be used as a security measure. Accordingly, a security monitoring system such as an anomaly detection system can use this security measure to improve its detection rate. Process-centric security measurements can be used in CPS security applications such as intrusion detection, anomaly detection, process verification, remote attestation, and integrity checking of CPS.

At least some embodiments provide an application, such as an IDS, that could extract the CPS state by parsing the network traffic and interfacing the CPS by the appropriate APIs. By providing these APIs and network protocols, the IDS is able to detect attacks that are encapsulated in the API and network protocols of the CPS.

In some implementations, the present security monitoring process and system may be an ADS that comprises a change point detector (CUSUM), statistical analysis, fuzzy logic, and/or a machine learning classifier. However, it will be appreciated that the process centric security measurement can be used in any other ADS.

Sensor measurements can be obtained from one or more physical processes in the CPS, and estimated values obtained based on physical models of the processes. The actuation commands will change the physical state of the system, and these changes of the physical state will be represented in the sensor readings. The unique pattern of each physical state and transitions between physical states can be used as a security measure.

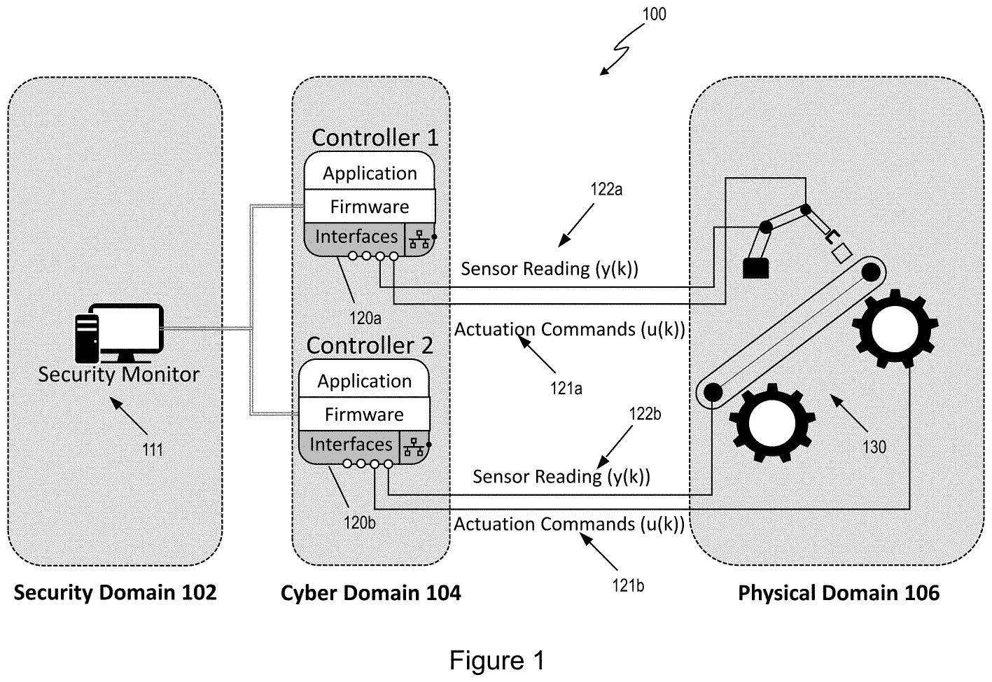

Turning now to FIG. 1, an example cyber-physical system (CPS) 100 is presented to illustrate certain concepts relevant to at least some embodiments. The cyber domain 104 of the CPS 100 has two controllers 120a and 120b, though it will be appreciated that more or fewer controllers may be present, depending (for example) on the number and type of actuators that they control. Each controller sends a set of actuation commands u(k) at time k. Controller 120a sends commands 121a, and controller 120b sends commands 121b, to change the physical state of the physical system 130, at the physical domain 106. The controllers (120a and 120b) read the physical state at time k via sensor readings y(k), referenced by 122a and 122b respectively in FIG. 1. The security monitor 111 at the security domain 102 receives the set of actuation commands u(k) at time k, and the set of sensor readings y(k) at time k, from the controllers (120a and 120b).

Considering a set of actuation commands u(k)=(u₁(k), u₂(k), . . . , uₙ(k)), and a set of sensor readings y(k)=(y₁(k), y₂(k), . . . , yₘ(k)), the physical state of the system would change according to the actuation commands u(k), and these actuation commands performed at time k will be represented (encoded) in the physical state k+1 with measurable random noise. The sensor readings y(k+1) represent the physical state k+1 with measurable random noise, and the actuation commands u(k) can be extracted (decoded) from the sensor readings.

The process-centric security measurement according to embodiments considers the unique pattern of the physical state in its security measurement. This unique pattern of the physical state may include the current physical state, transition between physical states, and the next possible physical state. In some embodiments, the noise of the current physical state has been found to improve the change-point detector and ML-based anomaly detection. It will be understood that other process-centric measurements can be used to improve the security measurer's performance.

“CUmulative SUM” (CUSUM) is a change-point detector that is based on addition operand and designed for real-time and fast detection of anomalies in real-time applications such as CPS. A CUSUM of normalised residuals between the estimated values and the sensor measurements can be determined, the normalised residuals being computed according to a difference between the residuals and a historical average of the residuals for the current process state. Then, based at least on the CUSUM, a detection process may be performed to determine whether there is an anomaly in the current process state, and an alert can be generated in accordance with the detection result.

In at least some embodiments, the CUSUM change-point detector considers the process state (sensor/actuator representation) in computation of the residual, resulting in even greater difficulty for a stealthy attacker. Furthermore, embodiments of the presently proposed detection mechanism add very little pre-computation overhead by pre-computing the physical process state information using a big data framework, and then providing the process state information to the detector.

In some embodiments, the present disclosure relates to a security monitoring process in the form of an anomaly detection technique that detects both cyber and physical anomalies by employing machine learning, state-aware anomaly detection, and/or network-based anomaly detection. In particular, certain embodiments may provide machine learning algorithms employing features from physical processes that consider process-centric measures in feature generation.

Embodiments provide a machine learning process employing cyber and physical process-centric features to detect stealthy attacks. In some embodiments, a change-point detector that considers the process-state is used as an input to ML-based ADS. Embodiments may use network traffic-derived features, in particular, cyber features (such as inter-arrival time), and physical process features (such as sensor readings, the physical state, and process estimation), as inputs to the ML algorithm.

Embodiments of the invention provide:

a) a framework for cyber and physical security analysis of the CPS that is able to provide CPS-specific API and protocols from the strategic points of the CPS;
b) process-centric security measurement for the CPS that consider the input (auction), and output (sensor reading) of the physical system in overall security measurement of the CPS;
c) a change-point detector anomaly detection that uses stateful anomaly detection technique, and it considers the process-centric security measurement (in this particular CPS, the process-state) during the anomaly detection process;
c) some machine learning anomaly detection techniques that consider the process-centric security measurement (in this particular CPS, the process-state) during the anomaly detection process; and/or
d) a detection framework with a set of comprehensive performance evaluations, leveraging process-centric security measurements.

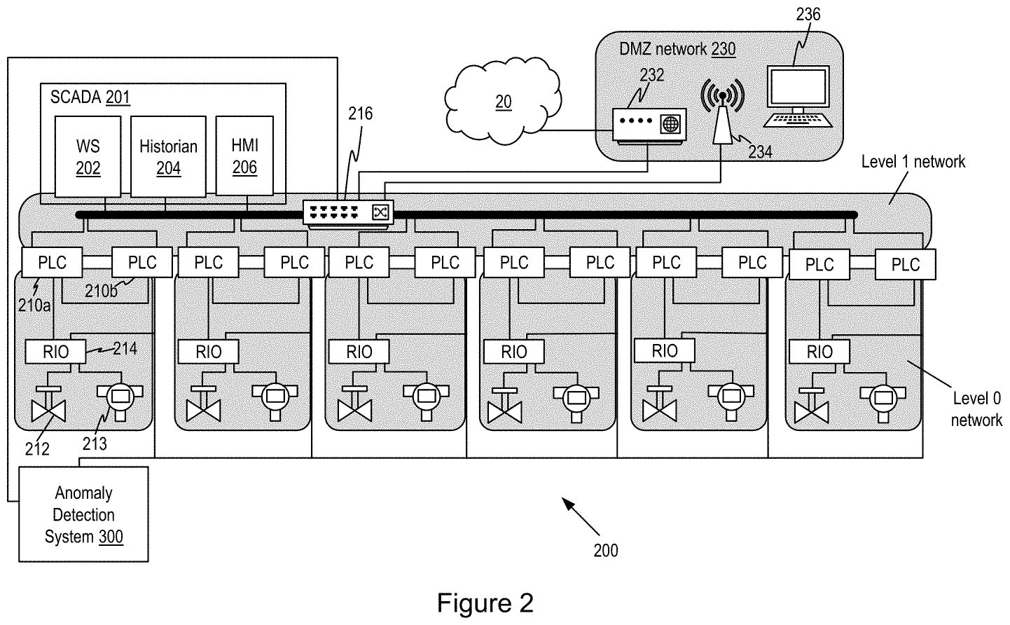

Turning now to FIG. 2, an example cyber-physical system (CPS) in the form of an industrial control system (ICS) 200 is shown. The ICS 200 comprises a plurality of components that are typical for such systems, such as a Supervisory Control and Data Acquisition (SCADA) system 201 that is responsible for high-level control and monitoring of processes in the ICS 200. The SCADA system 201 may comprise one or more engineer workstations 202, a historian system 204 that provides data capture, validation, compression, and aggregation capabilities, and a human-machine interface (HMI) 206 that enables a human operator to observe, and potentially manually override, the operation of individual components of the ICS 200, such as actuators or other process control devices. SCADA 201 may also comprise one or more remote workstations 236 that are part of a DMZ network 230 and accessible via a wide-area network (WAN) 20 such as the public Internet, for example. For example, a remote workstation 236 may be connected to WAN 20 via a router 232 or wireless access point 234.

The ICS 200 implements one or more physical processes under the control of respective programmable logic controllers (PLCs) 210a, 210b which, in turn, are controlled at a high level by SCADA system 201. For example, each PLC 210a or 210b may control the operation of and/or obtain data from an actuator 212 or a sensor 213, communicating with these components via a Remote I/O (RIO) unit 214. In the example shown in FIG. 2, six physical processes are implemented in the ICS 200, but it will be appreciated that fewer, or even many more, processes than this can be implemented. Only one PLC 210a is required to control the components in a physical process, but it is typical for an ICS process stage to include a second PLC 210b connected to the first PLC 210a, and to the physical components (sensors and actuators) in a ring topology, to provide redundancy.

An example of an ICS 200 is the SWaT (SecureWater Treatment) plant, which is a model six-stage process plant of industrial water treatment systems, designed for cyber-physical security research. Initially, the SWaT plant receives raw water in a first stage, with inflow being controlled by opening and closing of a valve. In a second stage, chemicals are added to the received raw water, and pumped to the next stage. Next, at an ultrafiltration stage, the received water will be filtered, and then it will be pumped to a dechlorination stage that uses UV lamps. Then, in a fifth stage, the water will be cleaned in a reverse osmosis process and stored in a permeate tank. Finally, in a sixth stage, an ultrafiltration pump is opened and closed to clean the membranes from the water. Embodiments of the present disclosure have been tested with a SWaT plant, but it is important to note that the same principles may be applied in non-research industrial control systems.

Various wired and/or wireless network connections may be provided in ICS 200 to enable the various components to communicate with each other. For example, PLCs 210a, 210b for a particular process may communicate directly with each other and with RIO 214, and with SCADA workstation 202, historian system 204 and HMI 206 via a switch 216.

The hierarchy of components of the ICS 200 may be described with reference to the Purdue Model for control hierarchy, as follows:

1. Site Manufacturing Operations and Control (Level 3/L3):

This level is designed for the management of the processes in the ICS 200. The most important parts of this level are Historian 204, SCADA workstation 202, network management devices such as switch 216, and engineering workstations (not shown).

2. Area Supervisory Control (Level 2/L2):

The area supervisory control contains manufacturing operations equipment. This level typically has HMI devices 206, control workstations (not shown), and alarm systems (not shown).

3. Basic Control (Level 1/L1):

This level contains process control equipment that read the sensor values, compute desired information and send the data to a desired destination. This level typically has distributed control systems (DCS), PLCs, and remote terminal units (RTU). These devices may have their own vendor provided operating system and software. Also, these devices are vulnerable to industrial control specific vulnerabilities.

4. Process (Level 0/L0):

This level contains sensors and instrumentation elements which are controlled by level 1 devices. This level typically has sensors 213 and actuators 212.

Returning to FIG. 2, the ICS 200 also comprises a security monitoring system in the form of an anomaly detection system 300. The anomaly detection system 300 receives and analyses sensor and network traffic data from the ICS 200. The sensor data may be received directly by anomaly detection system 300 (via RIO units 214, for example) from the sensors 213, and/or via PLC 210a or 210b that is in communication with sensor 213, and/or via the historian system 204. The actuator data may be received directly by anomaly detection system 300 (via RIO units 214, for example) from the actuators 212, and/or via PLC 210a or 210b that is in communication with actuator 212, and/or via the historian system 204. Network traffic data may be received from historian system 204, and/or from dedicated monitoring devices, such as intrusion detection system (IDS) modules that are connected at various points in the ICS 200. For example, IDS modules may be connected to PLCs 210a, 210b, switch 216, and/or at other strategic points in the network. In one example, IDS modules are in the device level ring (DLR) between PLCs 210a, 210b and RIO 214, and bridge the ring.

An example architecture for monitoring network traffic in industrial control systems is called HAMIDS, and is described in H. Ghaieni and N. Tippenhauer, “HAMIDS: Hierarchical Monitoring Intrusion Detection System for Industrial Control Systems”, CPS-SPC'16, Oct. 28 2016, Vienna, Austria, the entire contents of which are incorporated herein.

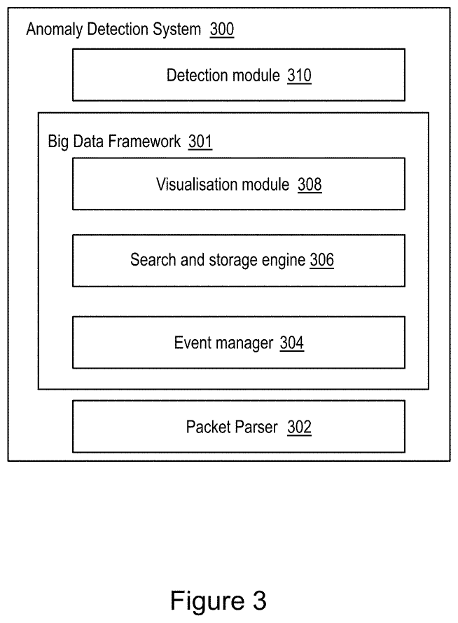

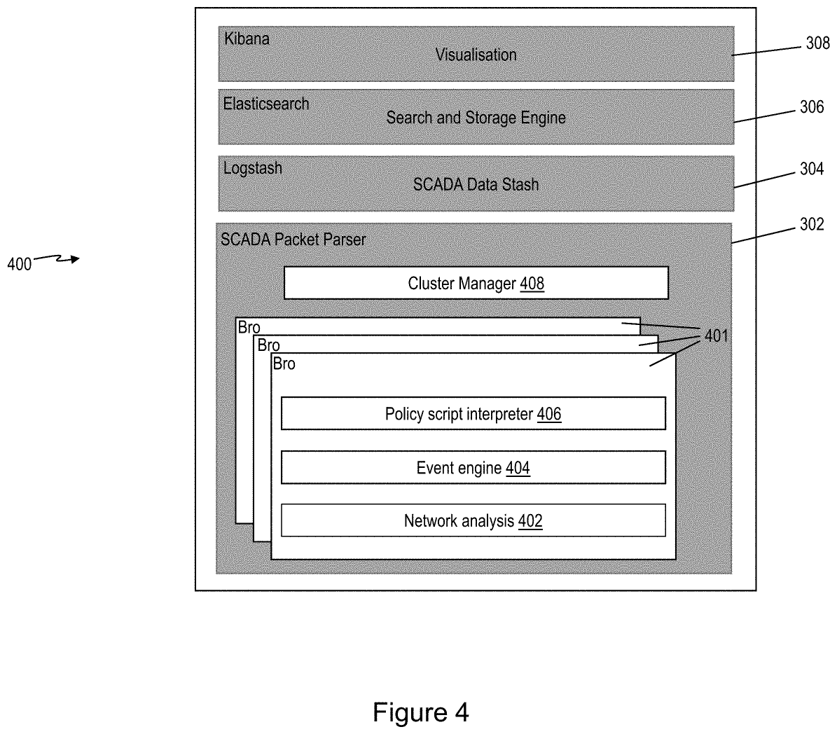

Further details of an exemplary anomaly detection system 300 are shown in FIG. 3. The anomaly detection system 300 may comprise a big data framework 301 for recording, analysing and visualising data from the ICS 200, including network packet data from various levels. Big data framework 301 may comprise the following modules:
A packet parser 302 that detects network data packets, parses them and generates logs of different network protocols, such as TCP, UDP, ARP, CIP or EtherNet/IP. The packet parser 302 may generate detailed log files for network-based intrusion detection, cyber features, and physical features. The cyber features may include the packet type, packet timing, and information regarding the packet payload. The physical features may be extracted from the packet payload, and can include actuator states, sensor readings, and control commands, for example. The packet parser 302 may be implemented at least partly in the IDS modules in the DLR. Alternatively, it may be implemented on an external computing device that is part of the anomaly detection system 302, and in communication with the IDS modules. In some embodiments, each IDS module may run an instance of the open source scripting platform Bro, though it will be appreciated that other like packet parsing tools may be implemented in the IDS modules. For example, as shown in FIG. 4, each Bro instance 401 may comprise a network analysis module 402, an event engine 404, and a policy script interpreter 406. The network analysis module 402 is responsible for real-time and abstract network packet handling and signature based intrusion detection. The event engine 404 records the events that are retrieved from network packet handling (such TCP sessions). However, our IDS is designed for complex IDS tasks that cannot be detected directly from the packet signature and events. The policy script interpreter 406 is designed to detect intrusions that cannot be picked up directly from the packet signature and events. However, some intrusions might not have any specific network packet signature or abnormal events, and the IDS is not sufficient to detect such attacks.
The packet parser 402 may also comprise a cluster manager 408 that receives and aggregates the processed packet data. An event manager 304 that receives the processed packet data and extracts therefrom industrial network protocol commands such as EtherNet/IP commands. The event manager 304 parses the packets that contain states and values of actuators 212 and sensors 213. The event manager 304 may be implemented using Logstash, for example. The output of the event manager 304 may be a SCADA data stash 410 (FIG. 4). In some embodiments, the event manager 304 may compute the residuals and CUSUM, as discussed in further detail below.
A search and storage engine 306 that enables rapid retrieval of pertinent data from its database and real-time search of the stored data. The search engine 306 may be capable of stream processing, for example. In some embodiments, the search engine 406 may be Elasticsearch or another search engine with like capabilities for real-time searching.
A visualisation module 308 that enables user analysis of data obtained by the search engine 306 (for example), and dashboard generation. In some embodiments, Kibana may be used as the visualisation module 308, as shown in FIG. 4.

Anomaly detection system 300 also comprises a detection module 310 (also referred to herein as a threat detector) that is configured to receive current process state and residual data from big data framework 301, for example from packet parser 302 and/or event manager 304 and/or search engine 306, and to detect the presence of an anomaly based at least on a change-point detector that is computed based on normalised residuals that are determined according to the current process state.

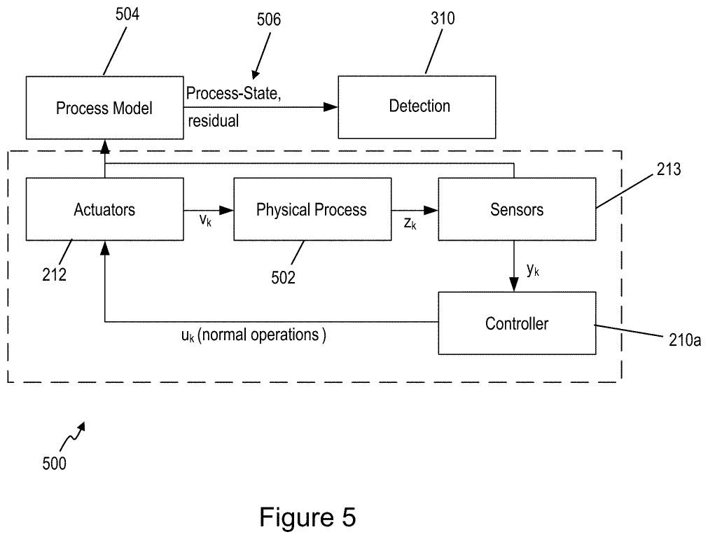

For example, in one possible framework 500 as illustrated schematically at high level in FIG. 5, a physical process 502 implemented via actuators 212 that are controlled by controller 210a is measured by sensors 213. The controller 210a sends control signals uₖ at time k to the actuators 212, and the sensors 213 return readings yₖ at time k. The values of uₖ and yₖ are extracted from network packets captured by big data framework 301, for example by IDS modules as discussed above. Additionally, general network traffic may be captured. Event manager 304 of big data framework 301 may process the captured data, in accordance with a process model 504 of the physical process 502, to determine process-state and residual data 506 that are then passed to detection module 310, which uses the input to choose appropriate parameters (e.g., mean of residuals in normal operation) for anomaly detection. In some embodiments, input data for detection module 310 may be obtained from the SCADA workstation 202 and/or the historian system 204, instead of, or in addition to, event manager 304.

The process model 504 can be learned from observations through a technique called system identification. For example, Auto-Regressive (AR) models or Linear Dynamical State-space (LDS) models can be used. The discussion below uses a Linear Dynamical State-Space (LDS) model. LDS models are a subset of state space models. Consider that the inputs (control commands uₖ) and outputs (sensor measurements yₖ) of the physical system are available. The dynamic modeling of the physical system will be:

xₖ₊₁=Axₖ+Buₖ+ϵₖ

yₖ=Cxₖ+Duₖ+eₖ (1)

where A, B, C and D are system matrices that are determined by system identification, k is the current time step of the system and k+1 is the next time step, xₖ is the system state of the estimated model, xₖ₊₁ is the next system state of the system, yₖ are sensor measurements at time step k, and eₖ and ϵₖ are sensor and perturbation noise, respectively.

State observers may be used to dynamically provide an estimation of the system with and without the noise. Industrial processes consist of a variety of states. Process states can be considered in at least some embodiments as an input of the anomaly detection system. As is known in the art, estimation of the system state of a dynamic system can be performed by methods such as Luenberger observers and the Kalman filter. Those techniques are used to dynamically estimate the system state with and without the noise, respectively. However, they provide only stateless anomaly detection, and have a number of other drawbacks. In the present disclosure, the sensor noise is considered as a significant parameter for system state detection. In addition, the process impact on the sensor noise model can be considered.

Consider p as a process of the industrial component that is being modeled. p is a representation of possible actuation commands and could range from 0 to upper bound of possible actuation commands minus 1. As an example, a pump in the ICS example 200, represented as 212, can be open or close. So, the p in a CPS that has only one actuator which is a pump can range from 0 to 1. If another example CPS has two actuators of pump, then the p can range from 0 to 3. Instead of computing the residual as an absolute difference between the measured and estimated (according to some model) sensor values, in the present disclosure the residuals are computed according to the actuation commands and system state (as described in process-centric security measurement). In particular, the residual can be normalized with its historical average μₚ for the current process state p (which p represent a specific actuation command u(k)):

r[t,p]=∥y[t]−ŷ[t]|−μₚ| (2)

where y is the observed sensor value, and ŷ is the output of the observer, i.e. the estimated sensor value computed by Equation (1).

μₚ is computed from historical data of the ICS physical process recorded while the process is in different process p. An underlying assumption is that during data collection time, no attack was conducted. For a given state p, μₚ can be computed as

μₚ= [symbol] (r[t,p])∀t where process state=p (3)

Based on the process dependent residual as defined in Equation (2), the CUSUM can be computed as follows:

$${S}_{k} = \{ \begin{matrix}0 & where k = 0 \\ {( {S}_{k - 1} + \vert {r}_{k} - {μ}_{p} \vert - α )}^{+} & where k \neq 0\end{matrix} \qquad ( 4 )$$

where (x)⁺ is the max(0, x) and α is a tuning value that is selected to keep |rₖ−μₚ|−α<0 under normal operation (a may be found on the sensors datasheet, or may be computed from sensor readings over time). This is a better CUSUM computation than that of the prior art, under hypothesis H₀ that considers states of the system; for each state, it uses μₚ as a tuning parameter.

Detection module 310 raises an alarm when the CUSUM passes a threshold. The threshold is usually set to twice the maximum CUSUM seen in normal operation (and also may be computed from ICS data-sheets). For example, the alarm can be displayed to a user through visualisation module 308, via workstation 202 or HMI 206, or transmitted to a remote user, such as a user of desktop 236 in DMZ network 230, or to a user of a mobile device that is registered with SCADA system 201 and/or anomaly detection system 300 to receive alarm notifications.

If the CUSUM passes the threshold at time k, it is reset, i.e. Sₖ₋₁=0. In some embodiments, it has been found that detection of an implemented example stealthy attack can be achieved in 30.66% less time than in prior art systems.

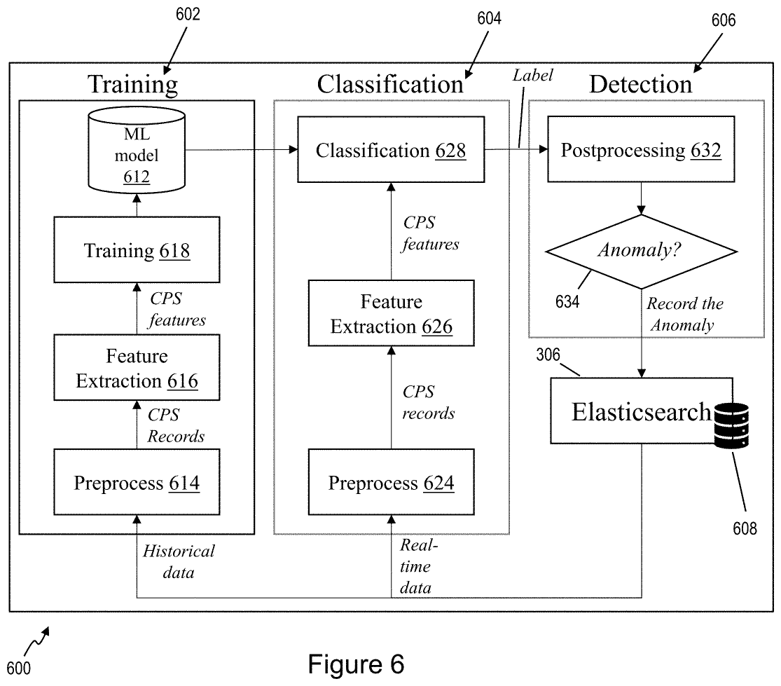

In the anomaly detection framework 600 of FIG. 6, a machine learning-based threat detector comprises three phases: a) Training 602: the training phase will be done with the historical record of the network packets that are labelled as “normal” or “attack”, b) Classification 604: the classification phase will be done during the operational process of the ICS and reads the real-time record of ICS network packets, c) Detection 606: at the detection phase, in case of a detected attack, after the post-processing 632 and detection of anomaly 634, the detected attack may be recorded in database 306.

The training phase 602 may generate a trained machine learning model 612, or other trained model capable of classifying data obtained from the ICS 200 as being either normal or anomalous (or suspicious in some way). A historical record of the network packets 608 may be requested from the database 306, and these historical records may be pre-processed 614 to generate the desired CPS records for the next component, which is a feature extraction component 616. The features may be extracted from the CPS records and passed to a classifier 618 which is trained to generate the machine learning model (ML model 612). The ML model 612 may be stored for real-time processing of real-time records of ICS network packets during operation of the ICS 200.

During the classification phase 628, a pre-processing component 624 that operates in like fashion to pre-processing component 614, and feature extraction component 626 that operates in like fashion to feature extraction component 616, will generate CPS features, and by using the stored ML model 612, a corresponding label for real-time records of ICS network packets can be generated. The CPS features together with the classification label may be passed to the post-processing module 632, and in the case of an anomaly 634, the anomaly may be recorded in the database 306.

The features that are used to train the ML model can be any combination of process state, physical state, and other process-centric measurements. For example, the current actuation commands, sensor signals, estimated sensor signals, residuals, and α window of the preceding actuation commands, sensor signals, estimated sensor signals, and residuals may be used as extracted features to train the ML model 612 of the anomaly detection framework 600.

The anomaly detection framework 600 is motivated by the following example attacker model. It will be appreciated that any adversarial attacker can be considered in the evaluation of the process-centric security measurement.

We consider an industrial control system with at least two connected process stages. The defender is monitoring the reported sensor and actuator data (i.e., by monitoring Fieldbus or SCADA traffic), and uses that data and the presently proposed detection mechanism to detect ongoing attacks as soon as possible and with acceptable false detection.

The attacker has either compromised a device such as a PLC in the target system or obtained access to the plant network through other means (e.g., by compromising a device in DMZ network 230 of FIG. 2). The attacker's goal is to manipulate the physical process state, e.g., to damage the system. To achieve that goal, the attacker can either manipulate data contained in network traffic, or compromise sensors or actuators to directly manipulate the sensing and actuation of the physical process while she will remain undetected by other conventional network security solutions, cyber anomaly detectors, or physical anomaly detection systems. The attacker wants to perform an attack that achieves the most significant impact in the shortest time, without triggering the detection mechanism. To achieve such a target, the attacker can be present at the level 0 network of the process.

The adversary has remote access to the ICS 200. She needs to compromise the ICS devices and find vulnerabilities inside the ICS to reach her goal. In addition, the level 0 network is isolated from the level 1 network, and the attacker needs to have access to this level of network or to compromise the PLCs 210a, 210b.

We consider a strong attacker that remains undetected in the system and can be present in isolated networks such as level 0 networks. An adversary having direct access to PLCs 210a, 210b has such a capability and eventually can change the physical reading of the process and can manipulate readings without triggering any alarm of typical anomaly detectors. Here, we demonstrate an example attack that does not trigger alarms in several conventional ICS security solutions.

To perform such an attack, the attacker should pass the presently proposed layered detection and rest in the ICS system 200 undetected. The attacker should know the vulnerability of the system and our cyber detection strategy. Eventually, the attacker will try to perform the physical attack while she tries not to pass the physical thresholds of the ICS or to change the detectable physical status anomalies. The attacker may target a sensor, such as a continuous water level reading sensor, that does not have a provable physical solution against physical attacks. To perform such a physical attack, the attacker needs detailed knowledge about the physics of the system, the process model used for anomaly detection, and the defender's detection strategy (thresholds and tuning values). The attacker shall solve a min-max game to maximize the impact of the attack while she is trying to minimize the overall computed CUSUM.

In some examples, an attacker could remain undetected by threshold-based change-point detectors. One such example is the Zero-Residual Attack (ZeRA), which is a novel stealthy attack which will not trigger state-of-the-art techniques that are threshold-based change-point detector techniques, and it will keep the attacked residual at a fraction of the actual residual. The ZeRA attack will generate a zero residual in control theoretical techniques such as stateless and stateful detection techniques. In addition to zero residual characteristics of the attack, the ZeRA will generate a residual as a fraction of the actual residual, which will make the detection of the stealthy attack more difficult.

To evaluate the detection performance of the detector, performance metrics such as precision, sensitivity, and Matthews correlation coefficient may be used. The definition of precision, sensitivity, and Matthews correlation coefficient will be known to those skilled in the art.

In some embodiments, it has been found that detection of an implemented example ZeRA attack can be achieved with precision above 99%, sensitivity above 99%, and Matthews correlation coefficient above 0.98.

Most cyber-physical systems follow a specific physical process and have a specific pattern of operation. This physical pattern will help the anomaly detection framework to provide a much more robust learned classifier. For example, a process may use a valve and pump. The valve and pump could each be opened or closed. Hence, in this example, there are four physical states in the process. It will be appreciated that the process might be inside a specific state or be at a transition between states. Being in a specific state, or in a transition between states, is contextual information that can be used to generate one or more features for input to the classifier.

The pump and valve status can be extracted directly from the payload of the industrial control network packets, as discussed above. These statuses can be used as features in the presently disclosed security monitoring process and system.

Residuals and CUSUM may be computed as defined previously in Equations (2) and (4). These may be also used as input features for the classifier 612, for example. Accordingly, the machine learning algorithm may use ICS cyber features, the context of the ICS, and ICS physical features to detect anomalies. Exemplary machine learning algorithms may be based on logistic model tree (LMT), PART, or random forests.

Embodiments of the disclosed detection scheme may provide a layered detection method having both cyber and physical components. For example, cyber intrusion detection may be implemented as an IDS extension based on Bro. The physical anomaly detection component (e.g. detection module 310) can be built at the top of the Bro packet parser (e.g. packet parser 302) and handle the Bro logs of the industrial packet payloads.

In detection of cyber attacks, certain embodiments may analyse cyber features like the timing of the packets or the payload of packets to find malicious patterns.

Examples of cyber attacks that can be detected by embodiments of the present disclosure include ARP poisoning, DHCP attacks, SYN flooding, PLC stop, PLC crash, ethernet crash, ethernet reset, and Fieldbus MitM. To this end, embodiments employ machine learning techniques to train a detector that uses network traffic features. In particular, embodiments may provide a machine learning technique that classifies the normal and abnormal packets based on the inter-arrival of the packets, in particular, the DLR packets. As an example, the adversary might start receiving the packets and take control of packet flows to perform a Fieldbus Man-in-the-Middle (MitM) attack. However, this will distort the timing of the packets. By observing the periodical pattern of communication in the industrial control system 200, it is possible to extract rules relating to packet inter-arrival times, and thus detect this abnormal traffic pattern.

Embodiments may implement signature-based intrusion detection, in which the packet content is analysed to find specific malicious patterns. As an example, the adversary might start sending packets to the PLCs 210a, 210b to run some EtherNet/IP CIP malicious commands. These attacks can be used to target the PLCs CPU and Ethernet controller of ICS 200 to simulate a real attack. To detect these attacks, the previously mentioned HAMIDS framework can be used, as it can detect ARP poisoning, DHCP attack, SYN flooding detection, and ICS-specific cyber attacks.

Embodiments of the present disclosure use IDS sensors inside the Fieldbus network, and can detect Fieldbus Man-in-the-Middle attacks that will distort the timing of the transmission packets. However, in the above-mentioned zero-day attack scenario where the attacker has taken control of a computing device or is present inside the Fieldbus network, she will not change the timing of the packets. Accordingly, it is advantageous to also perform physical anomaly detection.

Embodiments of a physical anomaly detection process select the functional anomaly detection parameters by a set of machine learning techniques, together with the context of the industrial control system. As discussed above, a strong attacker might perform an attack close to the noise behavior in normal operation of the ICS, while causing a physical impact to the ICS. Embodiments of the present disclosure are able to detect those attacks by a set of machine learning techniques.

Embodiments of the present disclosure consider process-centric measurements in change-point detectors and ML-based anomaly detectors, and by providing the process-centric measurements, the present disclosure is able to detect ZeRA attacks that will not be detected by prior change-point detectors and ML-based anomaly detectors.

Throughout the specification the aim has been to describe certain embodiments without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the appended claims.

1. A security monitoring process for a cyber-physical system, the process comprising:
obtaining, from one or more sensors of the cyber-physical system, a plurality of sensor measurements relating to a physical process in the cyber-physical system, the physical process having a current process state;
performing a threat detection operation comprising determining, based on a model of the physical process and the current process state, whether the plurality of sensor measurements correspond to a security threat to the cyber-physical system.

2. A process according to claim 1, wherein the threat detection operation comprises determining a corresponding plurality of estimated values for the at least one parameter based on the model of the physical process; and determining whether the estimated values differ from one or more expected values for the at least one parameter given the current process state.

3. A process according to claim 2, comprising:
determining residuals between the estimated values and the sensor measurements;
determining a cumulative sum (CUSUM) of normalised residuals, wherein the normalised residuals are computed according to a difference between the residuals and α historical average of the residuals for the current process state;
based at least on the CUSUM, detecting whether there is an anomaly in the current process state; and
responsive to detection of an anomaly, generating an alert.

4. A process according to claim 3, wherein the detection of the anomaly is based on a comparison of the CUSUM with a threshold.

5. A process according to claim 1, wherein the model is based on system identification.

6. A process according to claim 5, wherein the model is an autoregressive model or a linear dynamical state space (LDS) model.

7. A process according to claim 1, wherein the threat detection operation comprises a classification operation using a trained model that is configured to output a class prediction based on one or more input features, and wherein at least one of the input features is derived from the plurality of sensor measurements.

8. A process according to claim 7, wherein the one or more input features are derived from one or more of: current actuation commands; sensor signals; estimated sensor signals; residuals between sensor signals and estimated sensor signals; a window of previous actuation commands; a window of previous sensor signals; a window of previous estimated sensor signals; a window of previous residuals between sensor signals and estimated sensor signals; a physical status of one or more devices implementing the physical process; a transition between physical statuses of the one or more devices; and one or more network traffic parameters of network traffic in the cyber-physical system.

9. A process according to claim 8, wherein one of the input features is a cumulative sum (CUSUM) of normalised residuals, wherein the normalised residuals are computed according to a difference between the residuals and α historical average of the residuals for the current process state.

10. A process according to claim 8, wherein the one or more network traffic parameters are derived from network packets at both process level and basic control level devices of the cyber-physical system.

11. A system for monitoring security in a cyber-physical system, the system comprising:
a packet parser configured to obtain, from network traffic in the cyber-physical system, a plurality of sensor measurements from one or more sensors of the cyber-physical system, the plurality of sensor measurements relating to a physical process in the cyber-physical system, the physical process having a current process state; and
a threat detector configured to determine, based on a model of the physical process and the current process state, whether the plurality of sensor measurements correspond to a security threat to the cyber-physical system.

12. A system according to claim 11, wherein the threat detector is configured to determine a corresponding plurality of estimated values for at least one parameter based on the model of the physical process; and to determine whether the estimated values differ from one or more expected values for the at least one parameter given the current process state.

13. A system according to claim 12, wherein the packet parser and/or the threat detector are configured to:
determine residuals between the estimated values and the sensor measurements;
determine a cumulative sum (CUSUM) of normalised residuals, wherein the normalised residuals are computed according to a difference between the residuals and α historical average of the residuals for the current process state;
based at least on the CUSUM, detect whether there is an anomaly in the current process state; and
responsive to detection of an anomaly, generate an alert.

14. A system according to claim 13, wherein the detection of the anomaly is based on a comparison of the CUSUM with a threshold.

15. A system according to claim 11, wherein the model is based on system identification.

16. A system according to claim 15, wherein the model is an autoregressive model or a linear dynamical state space (LDS) model.

17. A system according to claim 11, wherein the threat detection operation comprises a classification operation using a trained model that is configured to output a class prediction based on one or more input features, and wherein at least one of the input features is derived from the plurality of sensor measurements.

18. A system according to claim 17, wherein the one or more input features are derived from one or more of: current actuation commands; sensor signals; estimated sensor signals; residuals between sensor signals and estimated sensor signals; a window of previous actuation commands; a window of previous sensor signals; a window of previous estimated sensor signals; a window of previous residuals between sensor signals and estimated sensor signals; a physical status of one or more devices implementing the physical process; a transition between physical statuses of the one or more devices; and one or more network traffic parameters of network traffic in the cyber-physical system.

19. A system according to claim 18, wherein one of the input features is a cumulative sum (CUSUM) of normalised residuals, wherein the normalised residuals are computed according to a difference between the residuals and α historical average of the residuals for the current process state.

20. A system according to claim 18, wherein the one or more network traffic parameters are derived from network packets at both process level and basic control level devices of the cyber-physical system.
